(19) United States
(12) Patent Application Publication
(10) Pub. No.: US 2009/0264108 A1
(43) Pub. Date: Oct. 22, 2009

(54) ANSWERING SYSTEM AND METHOD OF A MOBILE PHONE

(75) Inventors: JU-MEI LI, Tu-Cheng (TW); JUNG-CHIEH WONG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/249,975

(22) Filed: Oct. 13, 2008

(30) Foreign Application Priority Data
Apr. 17, 2008 (CN) 200810301174.6

(51) Int. Cl. H04M 3/533

(52) U.S. Cl. 455/413

(57) ABSTRACT

An answering system of a mobile phone is disclosed. The system comprises: a setting module configured for setting an allowable ringing time period and an allowable recording time period for the mobile phone; a calculagraph configured for counting a ringing time when the mobile phone receives an incoming call; a processing module configured for prompting for an option selection input if the ringing time has reached the allowable ringing time period; and the processing module further configured for playing a voice message stored in a storage system of the mobile phone or recording a new voice message. A related method is also disclosed.

### BACKGROUND

1. Field of the invention

Embodiments of the present disclosure relate to answering systems and methods, and particularly to an answering system and method of a mobile phone.

2. Description of related art

Usually, when the owner of a telephone is away from the telephone and does not answer the call, a caller may leave a message on a voicemail system provided by a third party provider (e.g., China Mobile). Thus, to retrieve the left message, the owner has to call the voicemail system for the left message. Such a call would increase communication fees for the user.

What is needed, therefore, is an answering system and method in a mobile phone to overcome the above-stated problems and facilitate playing back or recording voice messages in the mobile phone.

### SUMMARY

In one aspect, the aforementioned needs are satisfied by an answering system of a mobile phone. The answering system comprises: a setting module configured for setting an allowable ringing time period and an allowable recording time period for the mobile phone; a calculagraph configured for counting a ringing time when the mobile phone receives an incoming call; and a processing module configured for prompting for an option selection input if the ringing time has reached the allowable ringing time period, playing back at least one voice message stored in a storage system of the mobile phone if the option selection is to play back the voice message, and recording a new voice message of the caller if the option selection is to record the new voice message; and a processor configured for receiving data and for executing one or more operations for the setting module, the processing module, and the calculagraph.

Other objects, advantages and novel features will become more apparent from the following detailed description of certain embodiments of the present disclosure when taken in conjunction with the accompanying drawings, in which:

### BRIEF DESCRIPTION OF THE DRAWINGS

FIG. 1 is a block diagram of one embodiment a mobile phone including an answering system.

FIG. 2 is a block diagram of function modules of the system of FIG. 1.

FIG. 3 is a flowchart of one embodiment of an answering method by using the system of FIG. 1.

FIG. 4 is a detailed flowchart of a procedure “a” of FIG. 3.

### DETAILED DESCRIPTION OF CERTAIN INVENTIVE EMBODIMENTS

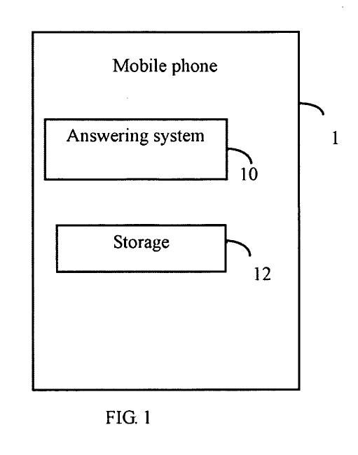

FIG. 1 is a block diagram of one embodiment a mobile phone 1 including an answering system 10. The mobile phone 1 also includes a storage system 12 for storing data used or generated by the answering system 10, such as voice messages. Depending on the embodiment, the storage system 12 may be a hard disk drive, a readable only memory (ROM), or some combination thereof, but the disclosure is not limited thereto.

The answering system 10 is configured for playing the voice messages stored in the storage system 12 when receiving a playback request selection, or recording a new voice message when receiving a record message request selection.

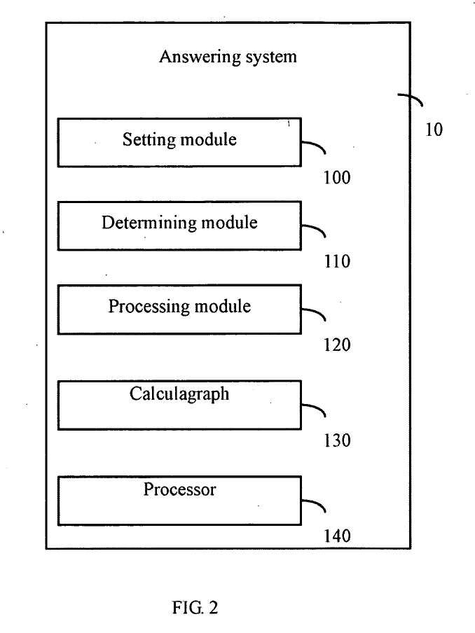

FIG. 2 is a block diagram of function modules of the answering system 10. In one embodiment, the answering system 10 includes a setting module 100, a determining module 110, a processing module 120 and a calculagraph 130. The modules 100, 110, 120 and the calculagraph 130 may be used to execute one or more operations of the mobile phone 1. Accordingly, a processor 140 may be used to receive data and execute one or more operations for the modules 100, 110, 120 and the calculagraph 130.

The setting module 100 is configured for setting an allowable ringing time period and an allowable recording time period for the mobile phone 1. The allowable ringing time period and the allowable recording time period may be set as 30 seconds, 1 minute, 2 minutes, and so on.

The calculagraph 130 is configured for counting a ringing time when the mobile phone 1 receives an incoming call. The determining module 110 is configured for determining if the ringing time reaches the allowable ringing time period.

The processing module 120 is configured for prompting for an option selection input. The processing module 120 may prompt for the option selection input in a form of playing a voice recording. For example, the voice recording may be “press ‘1’ to play back messages,” and “press ‘2’ to record messages.” In another embodiment, the processing module 120 may further prompt for a password before playing back the messages for security.

The processing module 120 is further configured for playing back the voice message stored in the storage system 12 if the option selection is to play back message, or recording a voice message left by the caller if the option selection is to record a new voice message.

The calculagraph 130 is further configured for counting a recording time when the caller begins to leave the voice message.

The processing module 120 is further configured for terminating or pausing recording the voice message of the caller if the recording time reaches the allowable recording time or the storage system 12 is full. In another embodiment, the processing module 120 may further prompt a message that the current call will be terminated in xxx seconds.

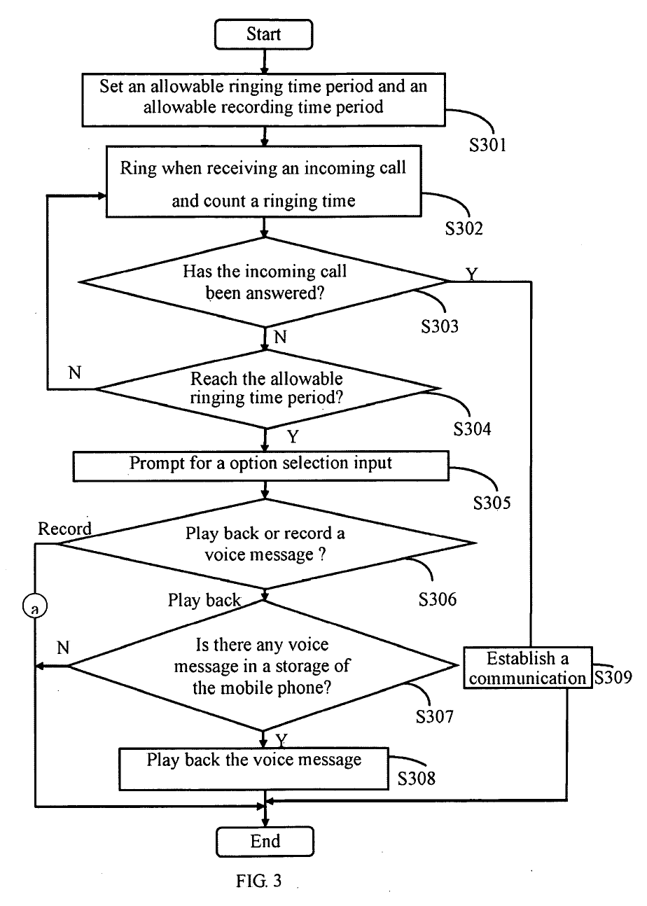

FIG. 3 is a flowchart of one embodiment of an answering method by using the answering system 10. Depending on the embodiment, additional blocks may be added, others deleted, and the ordering of the blocks may be changed. In block S301, the setting module 100 sets the allowable ringing time period and the allowable recording time period for the mobile phone 1. The allowable ringing time period and the allowable recording time period may be set as 30 seconds, 1 minutes, 2 minutes, and so on.

In block S302, the mobile phone 1 rings when receiving an incoming call. At the same time, the calculagraph 130 begins to count a ringing time of the incoming call.

In block S303, the determining module 110 determines if the incoming call has been answered. If the incoming call has been answered, the procedure goes to block S309 to establish a communication. Otherwise, if the incoming call has not been answered, in block 304, the processing module 120 determines if the ringing time has reached the preset allowable ringing time period.

If the ringing time has reached the preset allowable ringing time period, in block S305, the processing module 120 prompts for an option selection input. Otherwise, if the ringing time has not reached the allowable ringing time period, the procedure goes back to block S302.

In block S306, the processing module 120 determines if to play back a voice message or record a new voice message in the mobile phone 1 according to caller's option selection. If the option selection is to record the new voice message, the procedure goes to or procedure “a”; otherwise, if the option selection is to play back the voice message, then the procedure goes to block S307.

In block S307, the processing module 120 accesses the storage system 12 and determines if there is any voice message in the storage system 12. If there is no voice message in the storage system 12, the procedure ends; otherwise, the procedure goes to block S308. In block S308, the processing module 120 plays back the voice message stored in the storage system 12.

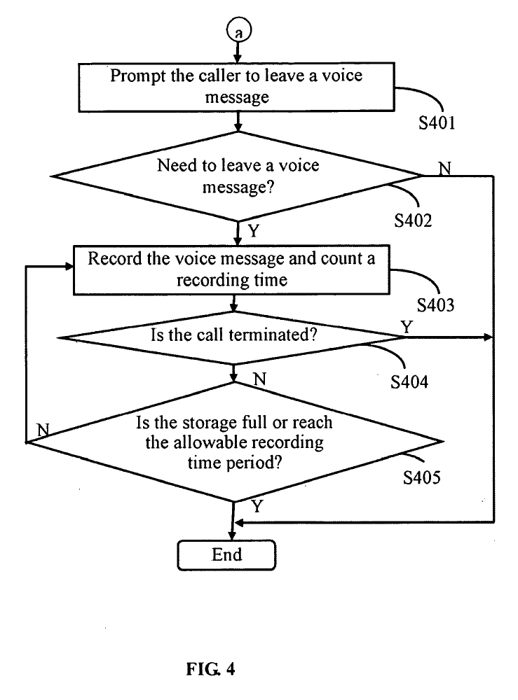

FIG. 4 is a detailed flowchart of the procedure “a” of FIG. 3. In block S401, the mobile phone 1 prompts the caller to leave a voice message if the caller select to leave the voice message. In one embodiment, the mobile phone 1 prompts for option selection to ‘leave’ or ‘abandon’ the voice message in voice recording. For example, the voice recording may be “press ‘1’ to leave a voice message,” and “press ‘2’ to abandon.” In block S402, the processing module 120 determines if the caller need to leave a voice message according to the caller's option selection. If the option selection is to ‘abandon’, the procedure ends, otherwise, the procedure goes to block S403.

In block S403, the processing module 120 records the voice message left by the caller, and the calculagraph 130 begins to count the recording time. In block S404, the processing module 120 determines if the current call has been terminated. If the call has been terminated, the procedure ends. Otherwise, in block S405, the processing module 120 determines if the storage system 12 is full or the recording time has reached the allowable recording time period.

If the storage system 12 is full or the recording time has reached the allowable recording time period, the procedure ends; otherwise, if the storage system 12 is not full or the recording time has not reached the allowable recording time period, the procedure goes to block S403.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An answering system of a mobile phone, comprising:
a setting module configured for setting an allowable ringing time period and an allowable recording time period for the mobile phone;
a calculagraph configured for counting a ringing time when the mobile phone receives an incoming call; and
a processing module configured for prompting for an option selection input if the ringing time has reached the allowable ringing time period, playing back at least one voice message stored in a storage system of the mobile phone if the option selection is to play back the voice message, and recording a new voice message of the caller if the option selection is to record the new voice message; and
a processor configured for receiving data and for executing one or more operations for the setting module, the processing module, and the calculagraph.

2. The system as claimed in claim 1, further comprising a determining module configured for determining if the ringing time has reached the allowable ringing time period.

3. The system as claimed in claim 1, wherein the calculagraph is further configured for counting a recording time when the mobile phone begin to record the new voice message of the caller.

4. The system as claimed in claim 2, wherein the processing module is further configured for terminating the call or pausing recording the voice message when the recording time has reached the allowable recording time period or when the storage system is full.

5. An answering method of a mobile phone, comprising:
setting an allowable ringing time period and an allowable recording time period for the mobile phone;
counting a ringing time when the mobile phone receives an incoming call;
prompting for an option selection input if the ringing time has reached the allowable ringing time period and the incoming call has not been answered;
playing back at least one voice message stored in a storage system of the mobile phone if the option selection is to play back the voice message; or
recording a new voice message left by the caller if the option selection is to record the new voice message.

6. The method as claimed in claim 5, wherein the step (c) further comprising a step of:
determining if the incoming call has been answered; and
determining if the ringing time has reached the allowable ringing time if the incoming call has not been answered.

7. The method as claimed in claim 5, further comprising a step of:
counting a recording time when the mobile phone begin to record the new voice message of the caller.

8. The method as claimed in claim 7, further comprising a step of:
terminating the call or pausing recording the voice message when the recording time has reached the allowable recording time period or when the storage system is full.

9. A mobile phone for answering phone calls, the mobile phone comprising:
a setting module configured for setting an allowable ringing time period and an allowable recording time period for the mobile phone;
a calculagraph configured for counting a ringing time when the mobile phone receives an incoming call; and
a processing module configured for prompting for an option selection input if the ringing time reaches the allowable ringing time period, playing back at least one voice message stored in a storage system of the mobile phone if the option selection is to play back the voice message, and recording a new voice message of the caller if the option selection is to record the new voice message; and
a processor configured for receiving data and for executing one or more operations for the setting module, the processing module, and the calculagraph.

10. The system as claimed in claim 9, further comprising a determining module configured for determining if the ringing time reaches the allowable ringing time period.

11. The system as claimed in claim 9, wherein the calculagraph is further configured for counting a recording time when the mobile phone begin to record the new voice message of the caller.

12. The system as claimed in claim 9, wherein the processing module is further configured for terminating the call or pausing recording the voice message when the recording time reaches the allowable recording time period or when the storage system is full.
